(19) United States
(12) Patent Application Publication
(10) Pub. No.: US 2011/0310243 A1
(43) Pub. Date: Dec. 22, 2011

(54) Method and Device for the Quality Assurance of at Least Partially Translucent Hollow Bodies

(75) Inventors: Gerd Fuhrmann, Aachen (DE); Klaus Schönhoff, Wurselen (DE)

(73) Assignee: Intravis Gmbh, Aachen (DE)

(21) Appl. No.: 13/201,151

(22) PCT Filed: Feb. 16, 2010
(86) PCT No.: PCT/EP10/51921

§ 371 Date: Aug. 11, 2011

(30) Foreign Application Priority Data
Mar. 5, 2009 (DE) 102009011270.7

(51) Int. Cl. H04N 7/18

(52) U.S. Cl. 348/92; 348/E07.085

(57) ABSTRACT

The invention pertains to a method and to a device for the quality assurance of an at least partially light-transmitting hollow body, the walls of which are illuminated by a light source, wherein a digital still camera is used to record images of various imaging areas of the walls containing useful data.

So that the images of the imaging areas containing the useful data can be recorded with as little interference as possible by means of a digital still camera and thus so that the discriminating power of the quality assurance process can be improved, the unwanted data located a certain distance away from the imaging area on the walls of the hollow body are suppressed by carefully achieved superimposition of partial images.

### CROSS-REFERENCE TO RELATED APPLICATIONS

The present application is a U.S. National Stage of PCT/EP2010/051921 filed 16 Feb. 2010. Priority is claimed to German patent application No. DE 10 2009 011 270, filed Mar. 5, 2009, the entire contents of which are incorporated herein by reference.

### BACKGROUND OF THE INVENTION

1. Field of the Invention

The invention pertains to a method and to a device for the quality assurance of an at least partially light-transmitting hollow body, the walls of which are illuminated by at least one light source, wherein at least one digital still camera is used to record images of different imaging areas of the walls containing useful data.

2. Description of the Related Art

These types of methods are used in particular in the quality assurance of ready-to-use hollow bodies or preforms. The usually cylindrical hollow bodies can comprise defects in the surface of their walls or in a layer near the surface. A hollow body for holding beverages can comprise defective printing, a defectively attached or embossed shield, a defective arrangement or embossing of patterns and structures, or inclusions in the plastic. So that such defects in the hollow body can be detected, images of different imaging areas of the walls are recorded with at least one digital still camera. An imaging area is usually part of the surface which comprises the useful data such as the printing, patterning, surface structure, or inclusions, i.e., the data which are necessary for a quality inspection. The imaging area is then compared with a reference image.

Hollow bodies, especially those for holding beverages, are usually at least partially light-transmitting (translucent/transparent). The property of partial light transmission is also called translucence. This means that the walls let some of the light pass through. In many cases, however, the hollow bodies let all of the light pass through, a property called transparency. In the recording of images with a digital still camera, the problem which is encountered when dealing with partially light-transmitting or completely light-transmitting hollow bodies is that the light which falls on the lens of the digital still camera consists not only of the light coming from the imaging area but also the light coming from an interference area, that is, an area containing unwanted data, situated on the wall of the hollow body a certain distance away from the imaging area. This is usually the side of the hollow cylindrical body opposite the imaging area, on which printing, inclusions, patternings, and the like can also be located, but which are not in the desired imaging area of the camera and which therefore interfere with the recording of the image in the imaging area.

### SUMMARY OF THE INVENTION

Proceeding from this prior art, the invention is based on the goal of creating a method and a device for implementing a method of the type indicated above in which the images of the imaging areas containing the useful data can be recorded by means of a digital still camera with almost no interference.

This goal is achieved in a method of the type indicated above in that both the light coming from the imaging area and the light containing unwanted data coming from the interference area on the wall of the hollow body a certain distance away from the imaging area fall on the lens of the digital still camera; in that adjacent imaging areas overlap by at least half in the recorded images; in that matching sets of useful data in the images recorded of the imaging areas and matching sets of unwanted data in the images recorded of the interference areas are located at different points in the images; and in that the overlapping areas of the images are superimposed by digital image processing in such a way that, in the overlapping areas, matching sets of useful data of the recorded images coincide, whereas the sets of unwanted data, which do not coincide as a result of this processing, are suppressed.

A device for implementing the method comprises a holder for a hollow body, a light source, at least one digital still camera, and a data processing unit.

Both the light coming from the desired imaging area and the light coming from the interference area, usually located behind the desired area, fall on the lens of each the at least one still camera. To eliminate the interference originating from the interference area from the produced image, it is necessary, first, to produce several images, wherein adjacent imaging areas of the walls of the hollow body overlap at least by half in the recorded images. Adjacent imaging areas, however, may not overlap completely in the recorded images, because otherwise it will not be ensured that matching sets of useful data from the imaging areas and matching sets of unwanted data from interference areas will be located at different points in the recorded images.

It is necessary for adjacent imaging areas to overlap at least by half in the recorded images for the sake of the following digital image processing step, in which the sets of useful data in the various overlapping areas of the images can be superimposed on each other to coincide, whereas the sets of unwanted data, which cannot be superimposed on each other to coincide because of the different axis of the camera to the hollow body, are suppressed.

So that a digital still camera can record images of different imaging areas of the walls of the hollow body, it is provided in an advantageous embodiment of the invention that relative movement between the hollow body and each digital still camera takes place between the recording of one image and the next.

According to the invention, the relative movement is achieved by moving the hollow body with respect to each of the stationary digital cameras with the help in particular of a holder for the hollow body, which comprises means for moving the hollow body held in it with respect to each of the stationary digital still cameras. The holder is designed as a turntable, for example, and is equipped with a rotary drive. The rotational axis of the turntable is concentric to the lateral surface of the cylindrical hollow body, which, between one image and the next, is rotated to such an extent that adjacent imaging areas overlap each other at least by half in the subsequently recorded images.

Alternatively, it is also possible in principle to use several digital still cameras to record the images without the need for relative movement between the hollow body and each of the digital still cameras. Here, too, however, it is necessary for adjacent imaging areas to overlap by at least half in the recorded images so that the necessary superimposition of the useful data and the suppression of the interference can be successfully performed. The cameras can be arranged in a ring-like manner, for example, around the cylindrical lateral surface of the hollow body. A device designed in this way, however, is associated with much higher cost.

The device for implementing the method comprises not only a holder for the hollow body in the area illuminated by at least one light source, this holder being rotated by a rotary drive, but also at least one digital still camera or several such cameras, the lens or lenses of which are aimed at the holder for the hollow body.

The still camera is connected to a data processing unit for processing the electronic image signals; the processing unit superimposes the overlapping areas, suppresses the interference, and compares the pattern of the images thus processed with a reference image or images of the hollow body. Depending on the results of this comparison, the inspected hollow body is identified as being of either satisfactory or unsatisfactory quality.

In an advantageous embodiment, the data processing unit is also connected to a control unit for actuating each of the digital still cameras and possibly for actuating the means for moving the holder. Through the calculated movement of the holder, the hollow body is brought into the proper position for the recording of the next image to be obtained. Then the digital still camera is automatically actuated by the control unit.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below on the basis of the figures:

FIG. 1 is a schematic diagram which illustrates an embodiment of the inventive method;

FIG. 2 is a schematic diagram of a device for implementing the method;

FIGS. 3-8 illustrate embodiments of the inventive method on the basis of the device according to FIG. 2;

FIG. 9 is a diagram of a quality assurance system with a device for implementing the inventive method;

FIG. 10 is a diagram of an enlarged part of the quality assurance system according to FIG. 9; and

FIG. 11 shows a diagram exclusively of the components of the device for implementing the inventive method, the other components of the quality assurance system being omitted.

### DETAILED DESCRIPTION OF THE PREFERRED EMBODIMENTS

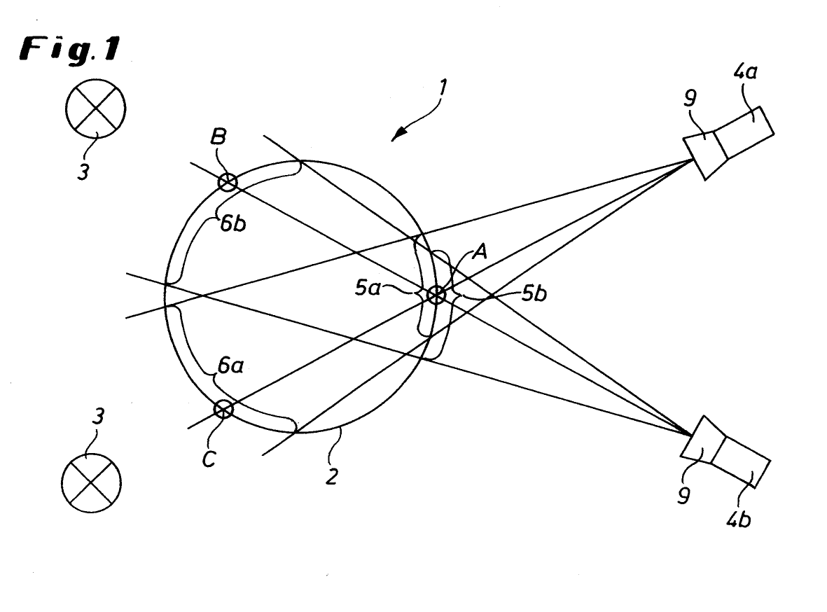

FIG. 1 shows a cross section of a transparent hollow body 1, such as a beverage bottle of PET, the walls 2 of which are illuminated by two light sources 3. Two digital still cameras 4a, b are used to produce images of different imaging areas 5a, b of the walls 2. In the exemplary embodiment shown here, useful data (A), such as a letter printed on the surface of the wall 2 of the hollow body 1, is situated in the area where the two imaging areas 5a, b overlap. A certain distance away from each imaging area 5a, b there is, on the wall 2 of the hollow body 1, an interference area 6a, b, wherein, in the exemplary embodiment shown here, the interference area 6a comprises the unwanted data (B), such as a letter of a printed label. It can be seen from the top view that the light coming from the imaging area 5b and from the interference area 6b a certain distance away falls on the lens of the still camera 4b and that the light coming from the imaging area 5a and from the interference area 6a a certain distance away falls on the lens 9 of the still camera 4a.

As previously mentioned, the imaging areas 5a, b overlap each other to such an extent that, in the images produced by the still cameras 4a, b, these adjacent imaging areas 5a, b overlap by at least half.

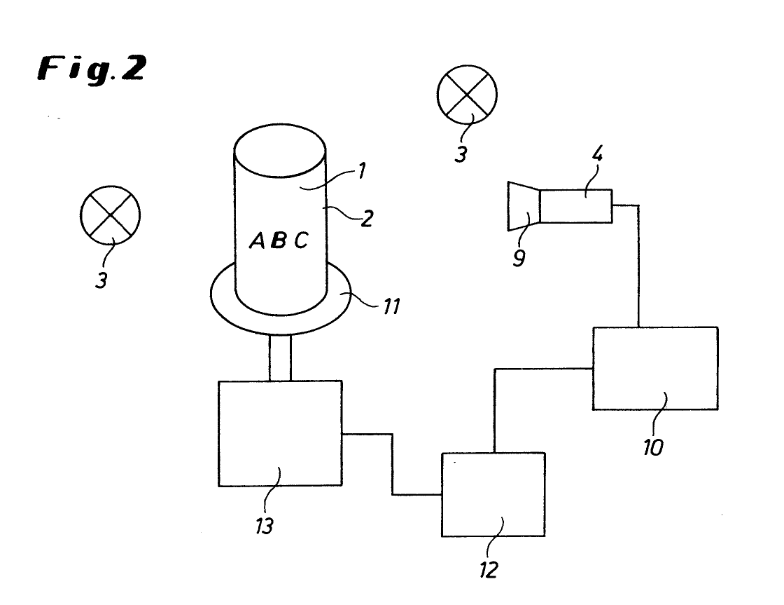

With the help of a data processing unit 10 shown in FIG. 2, the images recorded by the still cameras 4a, b are superimposed on each other in such a way that the matching sets of useful data (A) present in the area where the two recorded images overlap coincide. As a result of the different camera perspectives, the sets of unwanted data B, C on the rear surface of the wall 2 coming from the interference areas 6a, b do not coincide and therefore can be suppressed by digital processing methods known in and of themselves.

As a result, therefore, the images of the imaging areas 5a, b are effectively freed of the unwanted data from the interference areas 6a, b. In the evaluation step, the method for quality assurance thus leads to better discrimination between hollow bodies of satisfactory quality and those of unsatisfactory quality, because the chance that a hollow body will be mistakenly found to be defective on the basis of unwanted data from the interference areas present in the recorded images is almost completely eliminated.

FIG. 2 shows a device for implementing the method in which the individual images of the imaging areas 5a, b and possibly of additional imaging areas are produced not by several still cameras 4a, b but by only one still camera 4. The hollow body 1 is located on a holder 11, such as a turntable, which is set up in the area illuminated by the two light sources 3. A certain distance away from the holder 11, the digital still camera 4 is arranged with its lens 9 aimed at the holder 11; the camera is connected to the data processing unit 10 for the processing of the electronic image signals. The data processing unit 10 is connected in turn to a control unit 12, especially for actuating the still camera 4 and for actuating the drive 13 of the holder 11.

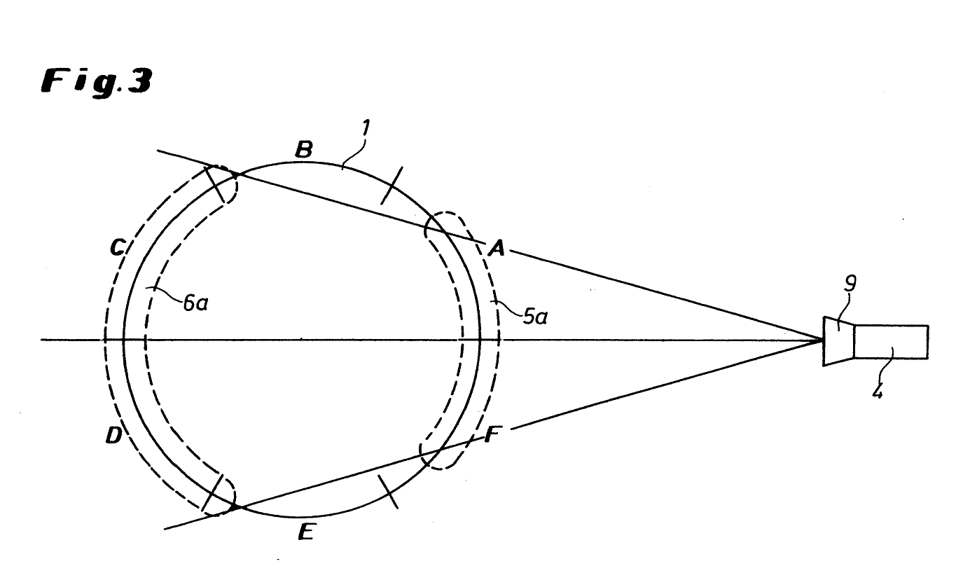

The inventive method using the device according to FIG. 2 is explained in greater detail below on the basis of FIGS. 3-8:

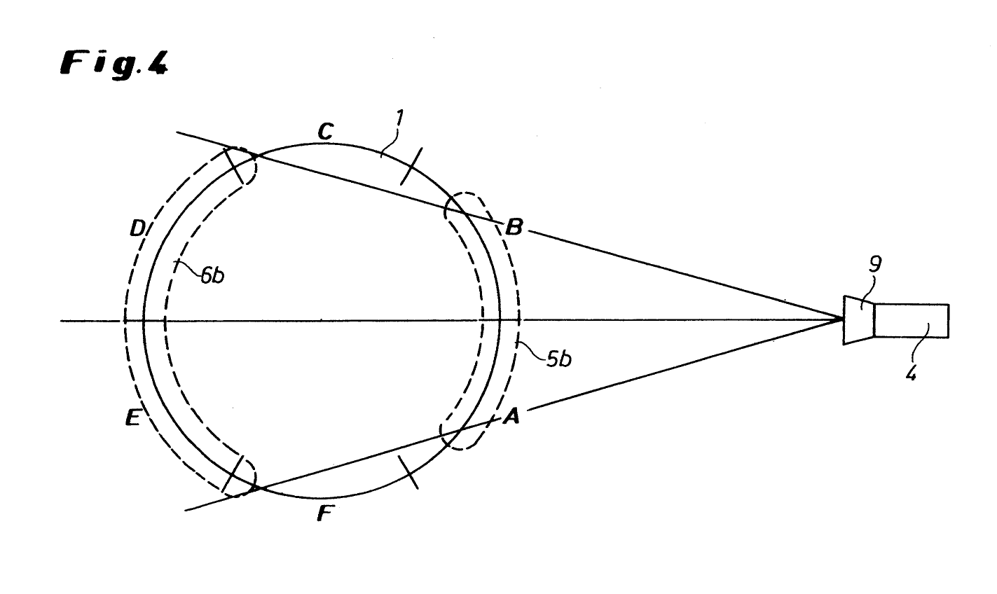

FIG. 3 shows a top view of the transparent cylindrical hollow body 1 and the still camera 4 aimed at the hollow body 1. For the sake of clarity, the light source 3, the data processing unit 10, the control unit 12, and the drive 13 for the turntable have been omitted from the diagram. The walls 2 of the hollow body 1 are printed around the circumference with the letters A-F. FIG. 4 shows the hollow body 1 after it has been rotated by the turntable in the clockwise direction around its central rotational axis by 60° after the recording of the first image.

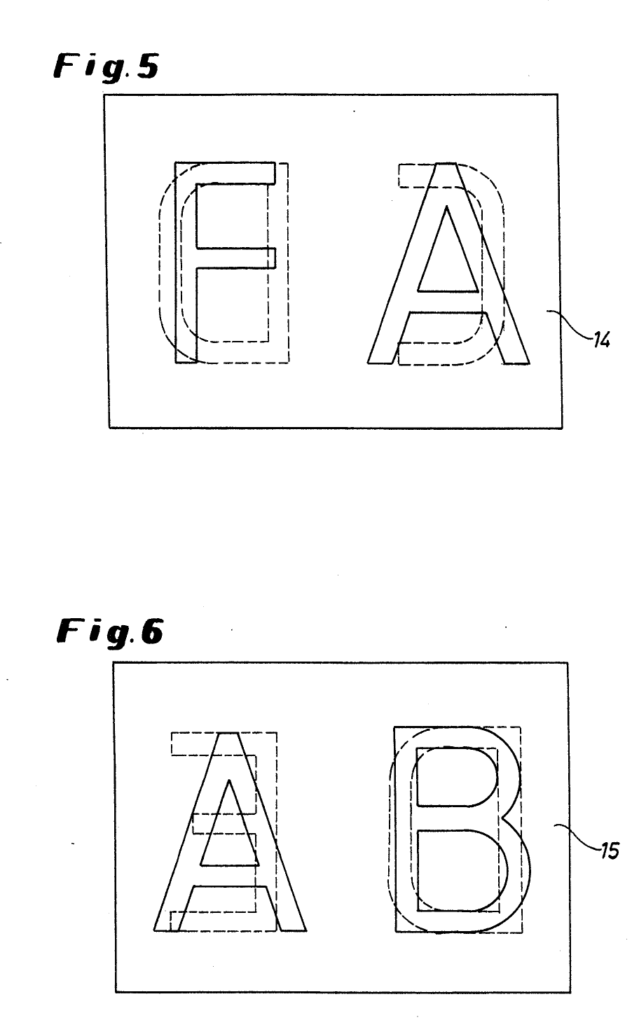

FIG. 5 shows the image 14 of the hollow body 1 produced by the still camera 4 with the hollow body in the position according to FIG. 3. FIG. 6 shows the image 15 of the hollow body 1 produced by the still camera 4 with the hollow body in the position shown in FIG. 4.

An image of the letter A is present in both images 14 and 15; in image 15, it is in the left half, and in image 14 it is in the right half, wherein the imaging areas 5a, b recorded in the images 14, 15 overlap by half. Letters F-A and A-B of images 14, 15, respectively, represent the useful data of the imaging areas of the walls 2 of the hollow body 1. The unwanted data in the form of the letters C-D and D-E, which are printed on the rear side of the hollow body in the interference area of two images, are recorded behind the useful data, reversed left to right. As a result, the corresponding letter A of the imaging areas is not imaged free of noise in either of the two images 14, 15 but rather is superimposed on the letters C-D and D-E on the rear side, which act as noise.

With the inventive device according to FIG. 2, six images 14-19, for example, each containing two letters, are recorded, wherein the hollow body 1 is rotated by 60° between the production of one image and the next.

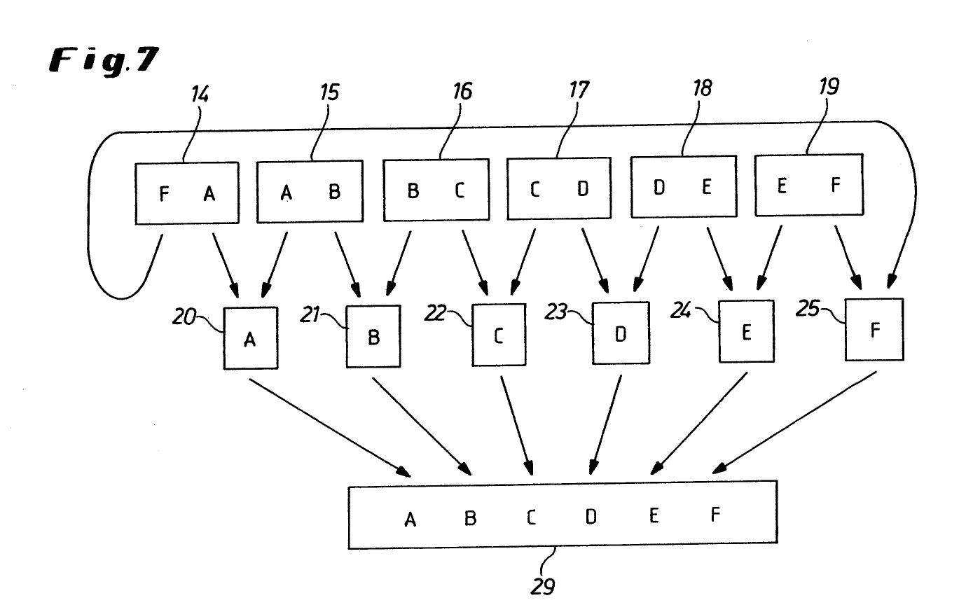

FIG. 7 shows how the six recorded images 14-19 are superimposed by matching overlapping halves of the images of successively recorded images with each other. The goal of this is to superimpose the matching sets of useful data of the recorded images 14-19 on each other so that only the image contents which coincide in the overlapping image halves are obtained, whereas the image contents which do not coincide in the same location after the superimposition, such as the unwanted data C and E in the case of images 14, 15, are suppressed. If the image contents of the sets of unwanted data coincide by way of exception, it is possible to improve the suppression of the interference by superimposing several images, at least one of which is different, that is, which does not coincide with another image of itself, at the location of the unwanted data in question. As a result of this superimposition, we obtain a sequence of processed, superimposed images 20-25, which contain only the useful data of the imaging areas. During the course of digital image processing, these superimposed images 20-25 can be stitched together first to form a developed view 29 for further evaluation, or they can be evaluated individually right away.

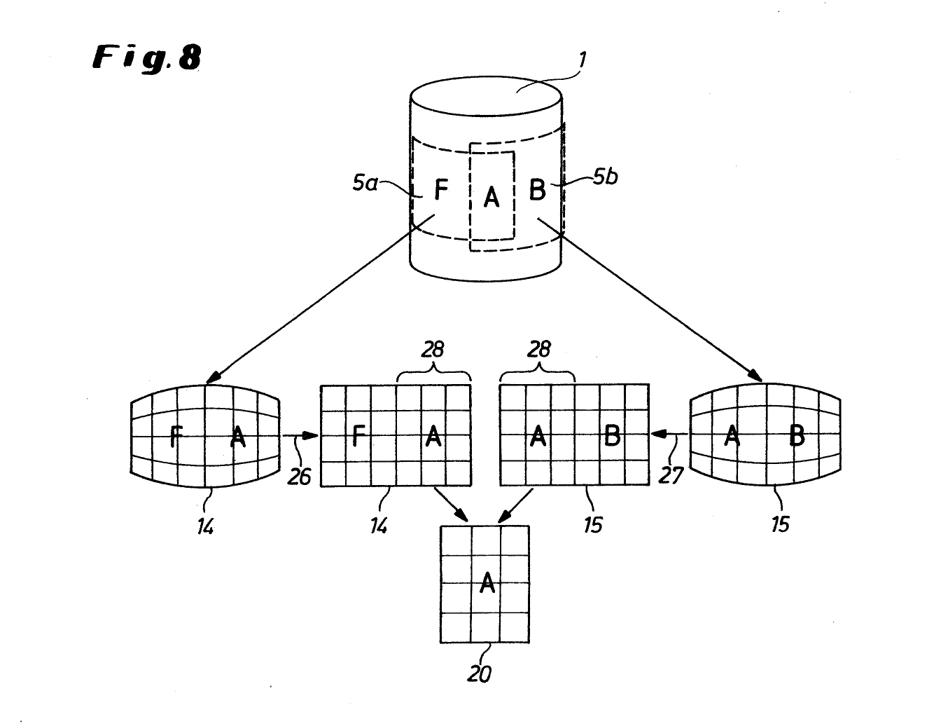

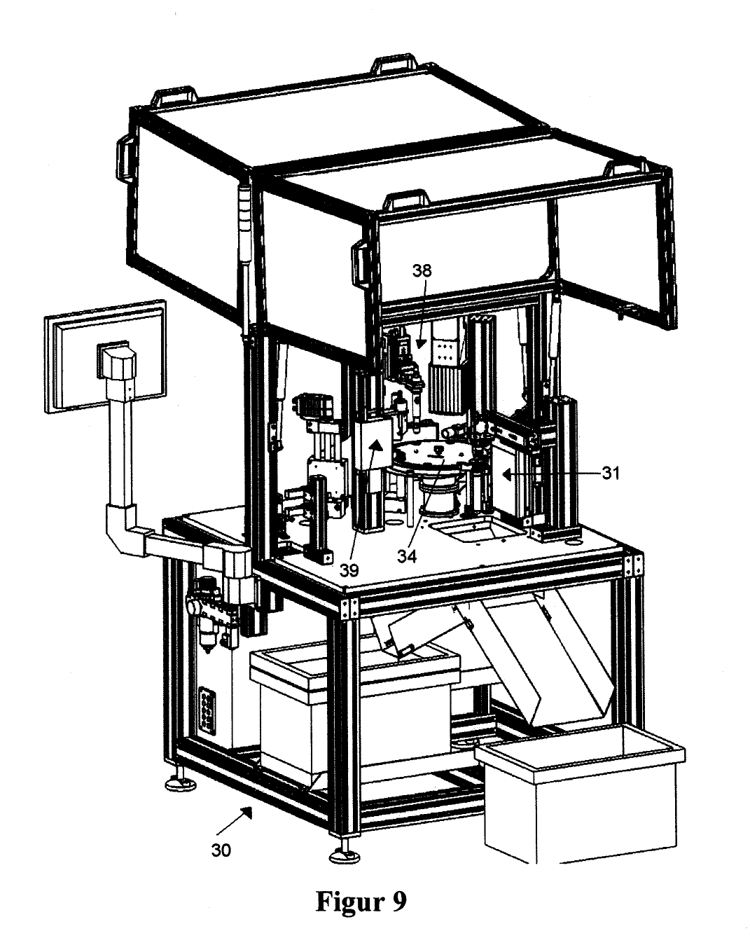

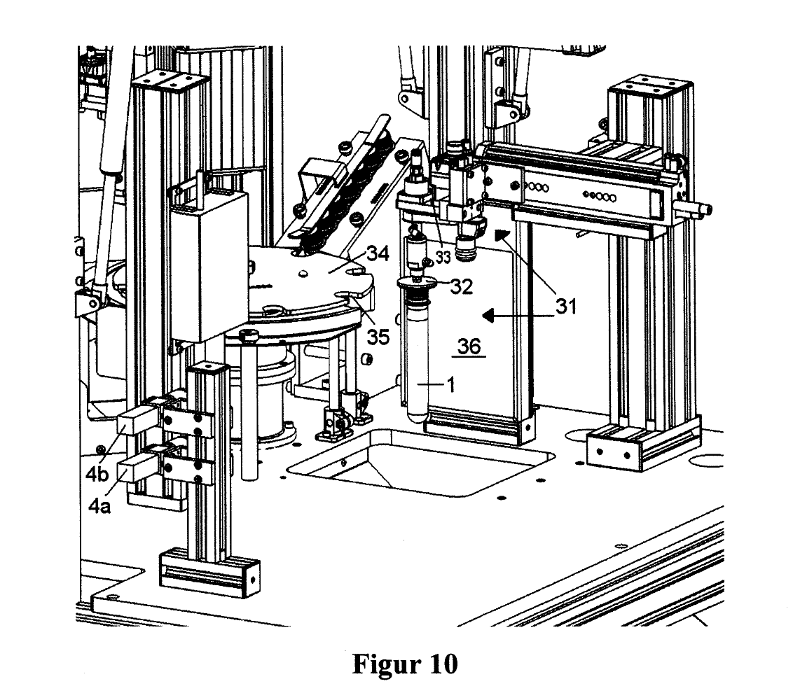

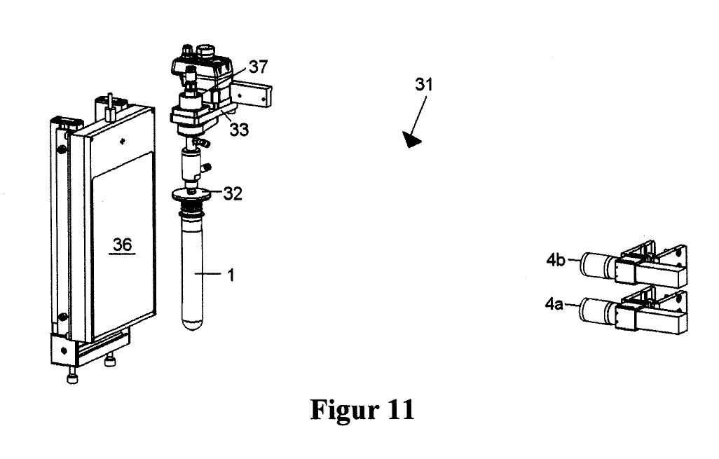

Depending on the geometric form of the hollow body 1, the superimposition process also includes a step of rectifying the image signals recorded by the digital still camera. During the course of this rectification, pixels from the imaging areas 5a, b of the hollow body 1 are shifted in such a way that pixels corresponding to the same positions on the surface of the hollow body 1 are positioned in the finished images 14-19 at the same coordinates as they had in the recorded image. In FIG. 8, the rectification of the images 14, 15 is characterized by the position numbers 26, 27. The overlapping areas 28 of the unrectified images 14, 15 can be matched with each other by comparing, for example, the gray-scale values of the various pairs of pixels to be matched. If the gray-scale values remain in a given tolerance range, either the larger, the smaller, or the mean value of the pixel values is carried over into the superimposed image 20. If the gray-scale values exceed the given tolerance range, a fixed value such as that which represents black or white is carried over into the superimposed image. In the superimposed images 20-25, these fixed values represent the background, from which the useful data to be emphasized are sufficiently distinguishable.

Another possibility of matching the overlapping areas 28 of the images 14-19 with each other consists in carrying over the minimum or maximum value from each pair of pixels in the overlapping areas of the images 14-19 to be matched into the superimposed images 20-25. Insofar as the useful data in the overlapping areas match, the maximum value of the pixels to be compared is carried over into the superimposed image. Insofar as non-matching, unwanted data are contained in the overlapping areas, the minimum value of the pixel comparison is carried over into the superimposed image. This method of suppressing noise is an especially good choice when, with respect to brightness, the useful data to be emphasized are either all lighter or all darker than the base colors of the hollow body and only a relatively small amount of useful or unwanted data is present on the surface of the hollow body, so that the base color of the hollow body 1 is also always represented among the pairs of pixels to be matched with each other.

A device 31 for implementing the method explained above on the basis of FIGS. 1-8 is integrated in particular into a quality assurance system 30 for transparent hollow bodies 1.

The device 31 comprises a suction plate 32, which is mounted on a movable arm 33 and arranged so that it can move vertically. The suction plate 32 is brought above the hollow body 1, which is open at the top, and lowered onto its opening. Then the air is drawn out of the interior of the hollow body 1, and the suction plate 32 is raised a few millimeters. The hollow body 1 is thus lifted from a pocket 35 of a pocket wheel 34 of the quality assurance system 30. The arm 33 is then moved until the hollow body 1 arrives in a test area between the two still cameras 4a, b and a luminous field 36 serving as a light source 3.

The hollow body 1 suspended from the suction plate 32 is rotated by a rotary drive 37 of the suction plate 32. Several images are recorded by the stationary still cameras 4a, b, typically 24 images. These images are superimposed by digital image processing according to the method described above in such a way that the data B, C representing noise are suppressed. This allows a satisfactory evaluation of the useful data A, such as the labeling, patterning, or structuring of the surface of the hollow body 1 for the purpose of quality inspection and assurance.

The other stations of the quality assurance system 30 serve different purposes not relevant to the present invention. A station 38 arranged on the circumference of the pocket wheel serves, for example, to set aside reserve samples of the hollow bodies, wherein a control unit, as a function of previously digitally recorded identification features of the hollow bodies, sets aside the reserve samples. Another station 39 uses spectrometry to examine the nature of defined surface areas of the molded parts 1 by means of a probe, which is inserted into the hollow body 1, and which records the light passing through the transparent wall of the hollow body 1.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested from or embodiment as a general matter of design choice.

1.-7. (canceled)

8. A method for quality assurance of an at least partially light-transmitting hollow body, comprising:
illuminating walls of the hollow body;
recording, by at least one digital still camera, images of different imaging areas of the walls that contain useful data, wherein both light coming from the imaging area with the useful data and light coming from an interference area containing unwanted data fall on a lens of the digital still camera during the step of recording, the interference area being disposed on the wall of the hollow body a distance away from the imaging area, adjacent ones of the imaging areas overlap by at least half in the recorded images;
wherein matching sets of the useful data in two of the recorded images of the imaging areas and matching sets of the unwanted data in the two of the recorded images are located at different points on the two of the recorded images;
superimposing overlapping areas of the two of the recorded images by digital image processing so that the matching sets of the useful data coincide and the sets of unwanted data do not coincide; and
suppressing the sets of unwanted data that do not coincide.

9. The method of claim 8, further comprising implementing a relative movement between the hollow body and each the at least one digital still camera between the recording of successive ones of the images.

10. The method of claim 9, wherein the relative movement includes moving the hollow body relative to the each at least one digital still camera.

11. The method of claim 8, the at least one digital still camera includes a plurality of cameras and said step of recording includes using the plural cameras to record a plurality of images without any relative movement between the hollow body and the cameras.

12. A device comprising,
a holder for holding at least partially light transmitting hollow body, including means for moving the hollow body;
at least one light source for illuminating walls of the hollow body;
at least one camera having a lens aimed at the holder and configured to record images of different imaging areas of the walls that contain useful data, wherein both light coming from the imaging area with the useful data and light coming from an interference area containing unwanted data fall on a lens of the at least one camera during the step of recording, the interference area being disposed on the wall of the hollow body a distance away from the imaging area, adjacent ones of the imaging areas overlap by at least half in the recorded images;
wherein matching sets of the useful data in two of the recorded images of the imaging areas and matching sets of the unwanted data in the two of the recorded images are located at different points on the two of the recorded images; and
a data processing unit connected to the at least one camera, the data processing unit configured to superimpose overlapping areas of the two of the recorded images by digital image processing so that the matching sets of the useful data coincide and the sets of unwanted data do not coincide, the data processing unit further configured to suppress the sets of unwanted data that do not coincide.

13. The device of claim 12, wherein the holder comprises a rotary drive.

14. The device of claim 13 further comprising a control unit, wherein the data processing unit is connected to the control unit for actuating at least one of each the at least one camera and the means for moving the holder.

15. The device of claim 14 further comprising a control unit, wherein the data processing unit is connected to the control unit for actuating at least one of each the at least one digital still camera and the means for moving the holder.
